(19) United States
(12) Patent Application Publication
(10) Pub. No.: US 2026/0075118 A1
(43) Pub. Date: Mar. 12, 2026

(54) NETWORK DEVICE, METHOD, AND STORAGE MEDIUM

(71) Applicant: CANON KABUSHIKI KAISHA, Tokyo (JP)

(72) Inventor: YASUHIRO IMAI, Tokyo (JP)

(21) Appl. No.: 19/312,498

(22) Filed: Aug. 28, 2025

(30) Foreign Application Priority Data
Sep. 6, 2024 (JP) 2024-153688

(51) Int. Cl. H04L 67/55; G06F 9/54

(52) U.S. Cl. CPC H04L 67/55; G06F 9/547

(57) ABSTRACT

A network device includes at least one memory storing instructions; and at least one processor executing the stored instructions causing the network device to: perform notification processing to display a first push notification on a user terminal in which software as a progressive web application for providing information regarding a state of the network device is installed, when a current state of the network device is in a state satisfying a predetermined state condition; and perform the notification processing to display a second push notification on the user terminal, when the user terminal is located within a range satisfying a predetermined range condition with respect to the network device after the first push notification has been displayed on the user terminal.

### BACKGROUND

### Field of the Technology

The present disclosure relates to a network device, a method, and a storage medium.

### Description of the Related Art

Conventionally, there is known a network device that causes a user terminal, which is a terminal used by a user, to notify information regarding the network device. Also known is a technology for sending a notification to a user terminal according to the position of a user. Japanese Laid-Open Patent Publication No. 2023-87994 discloses a technology in which an information processing apparatus serving as a network device determines whether or not to provide a notification to a user based on a change in the position information of the user.

Here, in a case in which a notification from the network device to the user terminal has been performed, the user may forget a requirement that has been notified to the user terminal. In this case, for example, even when a notification from the network device to the user terminal is performed while the user is away from the network device, there may be a case in which the user does not recognize the presence of the network device when the user approaches the network device. Additionally, for example, there may be a case in which a notification from the network device to the user terminal is realized by causing application software such as a native application to be installed in the user terminal. In this case, since it is necessary to perform a setting of a notification from the network device on each user terminal individually, the setting related to the notification from the network device to the user terminal has been complicated.

### SUMMARY

The present disclosure is directed to enabling a user who has approached a network device, which requires notification to be sent to a user terminal, to recognize the presence of the network device without requiring notification settings to be performed individually on each user terminal.

In order to solve the above-described problem, a network device according to the present disclosure includes at least one memory storing instructions; and at least one processor executing the stored instructions causing the network device to: perform notification processing to display a first push notification on a user terminal in which software as a progressive web application for providing information regarding a state of the network device is installed, when a current state of the network device is in a state satisfying a predetermined state condition; and perform the notification processing to display a second push notification on the user terminal, when the user terminal is located within a range satisfying a predetermined range condition with respect to the network device after the first push notification has been displayed on the user terminal.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a function providing system.

FIG. 2A is a diagram illustrating a hardware configuration of a device, FIG. 2B is a diagram illustrating a hardware configuration of a user terminal, and FIG. 2C is a diagram illustrating a hardware configuration of a server device.

FIG. 3A is a diagram illustrating a functional configuration of a device, FIG. 3B is a diagram illustrating a functional configuration of a user terminal, and FIG. 3C is a diagram illustrating a functional configuration of the server device.

FIG. 4 is a diagram illustrating a reception screen.

FIG. 5 is a sequence diagram illustrating a flow of processing performed by the device, the user terminal, and the server device.

FIG. 6 is a flowchart illustrating the flow of a re-notification process.

FIG. 7 is a diagram illustrating a screen.

FIG. 8 is a diagram illustrating a screen.

FIG. 9A is a diagram showing an initial notification image, and FIG. 9B is a diagram showing a re-notification image.

FIG. 10A is a diagram illustrating the hardware configuration of a transmitter, and FIG. 10B is a diagram illustrating a functional configuration of the transmitter.

FIG. 11 is a sequence diagram illustrating a flow of processing performed by the device, the user terminal, the server device, and the transmitter.

FIG. 12A is a diagram illustrating a re-notification screen, and FIG. 12B is a diagram illustrating a group screen.

FIG. 13 is a diagram illustrating a top screen.

### DESCRIPTION OF THE EMBODIMENTS

### First Embodiment

Hereinafter, embodiments of the present disclosure will be explained with reference to the drawings.

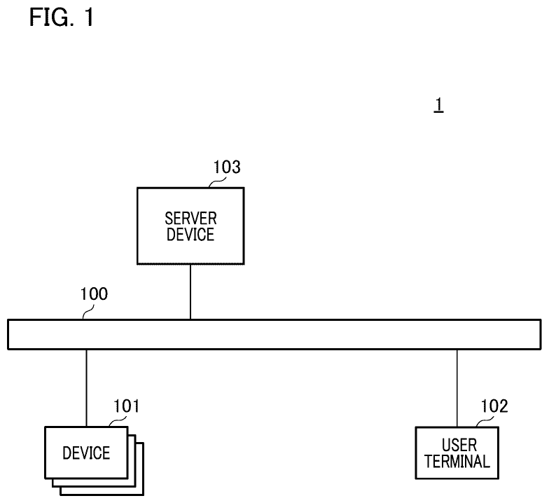

FIG. 1 is an overall configuration diagram of a function providing system 1. The function providing system 1 is a system that provides at least a part of the functions of a network device that is a device capable of communication to a terminal of a user that is connected to the network device. Additionally, in the present embodiment, the function of the network device provided to the terminal of the user is a function for monitoring a state of the network device. The device provides information to be monitored to a user terminal by sending a notification to the user terminal. Note that examples of the network device include an image processing apparatus such as a multifunction peripheral (MFP). However, the device may be a device other than an image processing apparatus, such as a network router, a monitoring camera, a digital medical device, an automobile, a delivery box, or a locker.

The function providing system 1 includes a device 101, a user terminal 102 that is a terminal used by a user, and a server device 103 used for notification from the device 101 to the user terminal 102. The device 101, the user terminal 102, and the server device 103 are connected to each other via a network 100.

The device 101 as an example of a network device is a device the state of which is to be monitored. Hereinafter, the device 101 is assumed to be a multifunction peripheral having functions such as printing, faxing, copying, scanning, and data transmission. The device 101 provides the user terminal 102 with functions for confirming the state of the device 101, performing job operations, and performing various settings. This function is referred to as a remote user interface (hereinafter, referred to as “remote UI”). Here, the device 101 includes a web server (not illustrated) capable of providing a remote UI inside the device.

Note that a mechanism for providing functions from the device 101 in the present embodiment is realized by using a Progressive Web Application (PWA). A PWA is a technology that enables a web application related to a website to be used as if it were an application operating on the user terminal 102. The PWA is application software that can be downloaded and installed via a web browser, and is constructed using general web technologies such as HTML, CSS, JavaScript, and Web Assembly. Additionally, for example, the PWA does not need to be downloaded and installed on the user terminal 102 by the user from an application store provided by a vendor that provides an operating system (OS). For example, in the case of a website that supports PWA, the user can use the PWA by accessing the website via a browser of the user terminal 102 and downloading the PWA. The content of the PWA can also be freely designed by the provider of the website. Additionally, in PWA, by utilizing a function Service Worker functionality, it is possible to realize push notifications to the user terminal 102, display of icons on the home screen, and the like from an application server constructed by the provider and the like of the website. These push notifications are realized via a push server provided by a vendor of the browser and the like, and at that time, a predetermined API supported by the OS or the browser of the user terminal 102 is used. Note that Service Worker is a script that operates as a background process.

The device 101 according to the present embodiment instructs the server device 103 to send a push notification to the user terminal 102 in a case in which a change occurs in the state of the monitored target, thereby causing the server device 103 to send a push notification to the user terminal 102. Additionally, in a case in which the user terminal 102 approaches after the push notification is sent, the device 101 causes the server device 103 to again send the push notification to the approaching user terminal 102.

Note that, in the illustrated example, three devices 101 are provided in the function providing system 1, the present invention is not limited thereto. The number of devices 101 provided in the function providing system 1 may be any number as long as the number is one or more.

The user terminal 102 receives a notification from the device 101. More specifically, when the user terminal 102 detects approach to the device 101, the user terminal 102 sends a request to the approached device 101 to issue a notification and receives the notification from the device 101 in response to the request. Examples of the user terminal 102 include computer devices such as a PC, a smartphone, and a tablet terminal. A web browser is installed in the user terminal 102, and the user terminal 102 connects to a URL of the remote UI by the user inputting the IP address of the device 101 into the web browser. Additionally, the user terminal 102 installs a PWA corresponding to a website (terminal site) accessed via the web browser.

Note that, in the illustrated example, although only one user terminal 102 is provided in the function providing system 1, the present invention is not limited thereto. The number of user terminals 102 provided in the function providing system 1 may be any number as long as it is one or more. Additionally, in the function providing system 1, the user terminal 102 may be provided for each user.

Hereinafter, it is assumed that the device 101 transmits a beacon signal to the surroundings, and that the beacon signal transmitted from the device 101 is received by the user terminal 102, whereby the user terminal 102 detects the approach to the device 101.

The server device 103 is a server device prepared by a browser vendor for providing a push service using a PWA. Upon receiving an instruction for push notification from the device 101, the server device 103 sends a push notification to the user terminal 102 that is a target of the instruction, thereby realizing the push notification from the device 101 to the user terminal 102.

Additionally, the server device 103 manages the position of the device 101 and provides a notification of the position of the device 101 to the user terminal 102.

In the present embodiment, although a single server device 103 performs both the push notification to the user terminal 102 and the notification of the position of the device 101 to the user terminal 102, the present invention is not limited thereto. The push notification to the user terminal 102 and the notification of the position of the device 101 to the user terminal 102 may be performed by a different server device.

The type of the network 100 is not particularly limited, as long as transmission and reception of data can be performed. Examples of the network 100 include the Internet, a local area network (LAN), a wide area network (WAN), a telephone line, a dedicated digital line, an ATM line, a frame relay line, a cable television line, and a wireless line for data broadcasting. Additionally, the communication line used for transmission and reception of data may be either a wired line or a wireless line. Additionally, the network 100 that connects the device 101 and the user terminal 102 and the network 100 that connects the device 101 and the user terminal 102 to the server device 103 may be the same network or may be different networks.

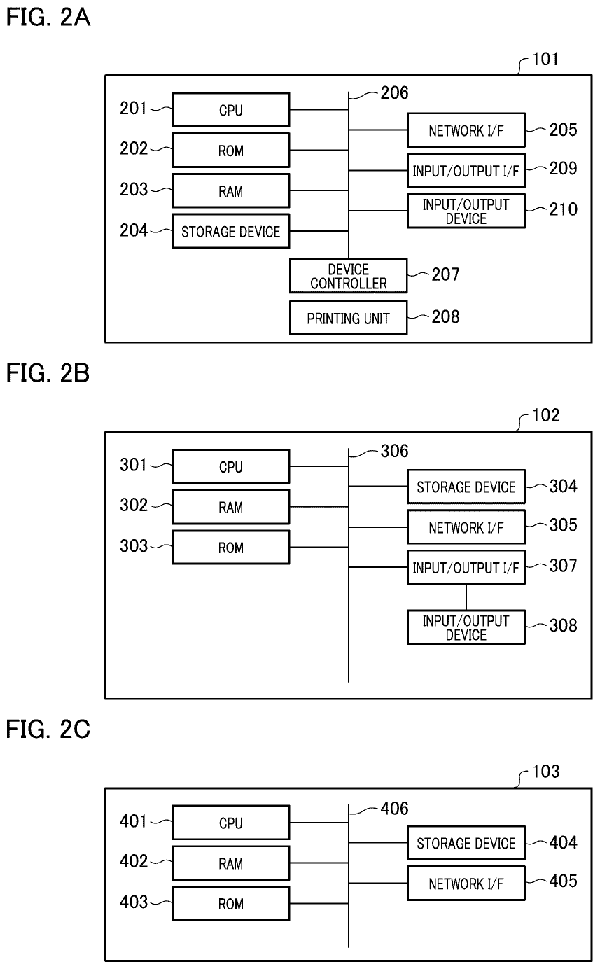

FIG. 2A is a diagram illustrating a hardware configuration of the device 101. The device 101 includes a CPU 201, a ROM 202, a RAM 203, a storage device 204, a network I/F 205, a device controller 207, a printing unit 208, an input/output I/F 209, and an input/output device 210. The CPU 201, the ROM 202, the RAM 203, the storage device 204, the network I/F 205, the device controller 207, the input/output I/F 209, and the input/output device 210 are each connected via a bus 206.

The CPU 201 is provided with a program stored in the ROM 202 and controls the entirety of the device 101. The RAM 203 functions as a memory and a work area of the CPU 201, and stores information indicating the detection state of the device 101, various counter information, consumption degree information of consumable parts, various logs, and the like. The network I/F 205 communicates with the user terminal 102 and the server device 103. The device controller 207 controls the printing unit 208 according to a print request and the like. The CPU 201 executes a program together with the ROM 202 and the RAM 203, and performs processing of recording image data on a recording medium such as the storage device 204. The storage device 204 functions as an external storage device, and stores image data and the like. Additionally, the storage device 204 may store the above-described information to be stored in the RAM 203, in place of the RAM 203. The input/output device 210 receives input of information from a user, such as scanning, button input, and the like, and outputs information. As the input/output device 210, a device such as a touch panel including an operation receiving unit and a display unit is exemplified.

FIG. 2B is a diagram illustrating a hardware configuration of the user terminal 102. The user terminal 102 includes a CPU 301, a RAM 302, a ROM 303, a storage device 304, a network interface I/F 305, an input/output I/F 307, and an input/output device 308. The CPU 301, the RAM 302, the ROM 303, the storage device 304, the network I/F 305, and the input/output I/F 307 are each connected via a bus 306.

The CPU 301 executes a program stored in the ROM 303 and controls the entirety of the user terminal 102. Additionally, the CPU 301 executes the program together with the RAM 302 and the ROM 303. The RAM 302 functions as a memory and a work area of the CPU 301. The storage device 304 functions as an external storage device and stores various types of information. Additionally, the storage device 304 stores the various types of information in place of the RAM 302. The network I/F 305 communicates with the device 101 and the server device 103. The input/output device 308 is a device such as a touch panel including an operation receiving unit and a display unit, and performs input and output of information via the input/output I/F 307.

FIG. 2C is a diagram illustrating a hardware configuration of the server device 103. The server device 103 includes a CPU 401, a RAM 402, a ROM 403, a storage device 404, and a network I/F 405. The CPU 401, the RAM 402, the ROM 403, the storage device 404, and the network I/F 405 are each connected via a bus 406.

The CPU 401 executes a program stored in the ROM 403, and controls the entirety of the server device 103. Additionally, the CPU 401 executes the program together with the RAM 402 and the ROM 403. The RAM 402 functions as a work area and a memory of the CPU 401. The storage device 404 functions as an external storage device and stores various types of information. Additionally, the storage device 404 stores various types of information in place of the RAM 402. The network I/F 405 communicates with the device 101 and the user terminals 102.

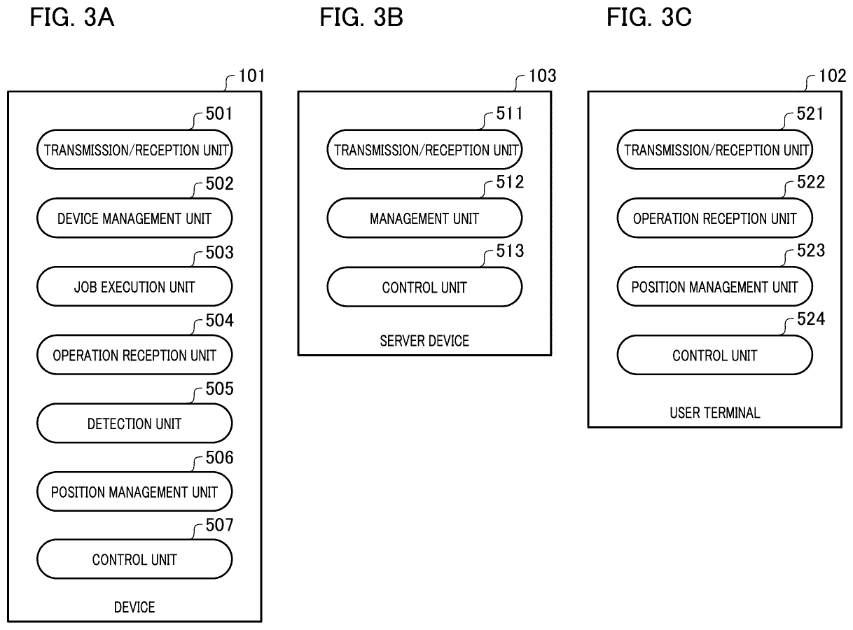

FIG. 3A is a diagram illustrating a functional configuration of the device 101. The device 101 includes a transmission/reception unit 501, a device management unit 502, a job execution unit 503, an operation reception unit 504, a detection unit 505, a position management unit 506, and a control unit 507.

The transmission/reception unit 501 communicates with external devices such as the user terminal 102 and the server device 103 to transmit and receive information to and from external devices. For transmission and reception of information, protocols such as SMTP, HTTP/HTTPS, SNMP, FTP, and SMB are used. Additionally, the transmission/reception unit 501 transmits a beacon signal to the surroundings.

The device management unit 502 manages information on the device 101 in the ROM 202, the RAM 203, and the storage device 204. Examples of the information on the device 101 managed by the device management unit 502 include identification information of the device 101, firmware version, network information such as an IP address, various counter information, and consumption degree information of consumable parts. The beacon signal transmitted by the transmission/reception unit 501 includes the identification information of the device 101 managed by the device management unit 502. Additionally, examples of the counter information include information indicating a value detected by a sensor (not illustrated) as the number of printed sheets in the device 101. Additionally, examples of the consumption degree information include information indicating a consumption degree of components configuring the device 101 and information indicating a remaining amount of toner in the device 101. Additionally, the information on the device 101 managed by the device management unit 502 may be operation history (such as job execution history and/or operation history) of the device 101 and history information (such as error history or alarm history) indicating various abnormal states in the device 101.

The job execution unit 503 performs control of the device 101 at the time of execution of a job such as a print job or a scan job. The job execution unit 503 generates and outputs print data to be passed to the printing unit 208, for example, at the time of execution of a print job.

The operation reception unit 504 receives an operation performed by the user on the user terminal 102.

The detection unit 505 detects occurrence of a predetermined state of the device 101. Examples of the predetermined state of the device 101 include an abnormal state accompanied by occurrence of an error or an alarm. Additionally, examples of the abnormal state accompanied by occurrence of an error or an alarm include a state in which an error with high urgency such as a hard disk error has occurred, a state in which a paper jam has occurred, a state in which a warning alarm indicating that the remaining amount of toner is small has occurred, and a state in which toner has become empty. Additionally, the predetermined state of the device 101 may be, for example, a state in which a toner bottle has been replaced, or a state in which firmware has been updated in the device 101. Upon detecting occurrence of the predetermined state of the device 101, the detection unit 505 provides a notification of information indicating the detection state to the control unit 507. Additionally, the detection unit 505 detects resolution of the predetermined state in the device 101 after the device 101 has entered the predetermined state. The state of the device 101 detected by the detection unit 505, such as the predetermined state or a state in which the predetermined state has been resolved, is managed by the device management unit 502 as history information of the state of the device 101. Note that the predetermined state of the device 101 detected by the detection unit 505 and to be notified by the detection unit 505 to the control unit 507 may be hereinafter referred to as a “detection state”.

The position management unit 506 manages position information indicating a position of the device 101. Examples of the position information include information indicating a point at which the device 101 is located, and information indicating a building, a floor, a room, and the like in which the device 101 is installed. The position information may be generated by a user inputting information to the device 101. Additionally, in a case in which the device 101 includes a detection unit that detects a position, such as a GPS, the detection unit may generate the position information. Additionally, the position management unit 506 manages the position information and identification information for identifying the device 101 in association with each other. The position management unit 506 transmits the position information and the identification information in association with each other, to the server device 103.

The control unit 507, which is an example of a control unit, causes the push notification to be performed for the user terminal 102. Specifically, when the occurrence of the detection state is notified from the detection unit 505, the control unit 507 causes a push notification to be sent by transmitting an instruction for push notification, together with information for identifying the user terminal 102 that is a target of the push notification, to the server device 103. Accordingly, the control unit 507 can also be regarded as a notification unit that causes a push notification to be performed for the user terminal 102.

Additionally, the control unit 507 causes the push notification to be sent again to the user terminal 102. The control unit 507, after causing an initial push notification to be performed for the user terminal 102 in response to being notified of the occurrence of the detection state from the detection unit 505, causes a push notification to be performed again to the user terminal 102 in a case in which the user terminal 102 approaches the device 101. Accordingly, the control unit 507 can also be regarded as a re-notification unit that causes a push notification to be sent again to the user terminal 102.

Additionally, the control unit 507 has a function as an application server, and provides web content in response to a request from the user terminal 102. The web content includes information to be displayed by a web browser on the user terminal 102, Service Worker, and the like.

Additionally, the control unit 507 transmits, to the server device 103, the position information of the device 101 managed by the position management unit 506, in association with instruction information indicating an instruction for the user terminal 102 that has approached the device 101, and identification information of the device 101. In the present embodiment, the instruction indicated by the instruction information is an instruction to request, from the device 101, a push notification to the user terminal 102. Additionally, the control unit 507 includes, in the instruction information, information necessary for communicating with the device 101, such as endpoint information, in order to cause a device that has acquired the instruction information to communicate with the device 101. Note that the instruction indicated by the instruction information is not limited to the instruction to request the push notification to the device 101. The instruction indicated by the instruction information may be an instruction to output information to the user terminal 102, and the like.

The transmission/reception unit 501 of the device 101 is realized by the network I/F 205. Additionally, the device management unit 502, the job execution unit 503, the detection unit 505, the position management unit 506, and the control unit 507 of the device 101 are realized by the CPU 201 executing a program stored in the ROM 202 or the storage device 204, the program being loaded into the RAM 203. Additionally, the operation receiving unit 504 of the device 101 is realized by the input/output device 210.

FIG. 3B is a diagram illustrating a functional configuration of the server device 103. The server device 103 includes a transmission/reception unit 511, a management unit 512, and a control unit 513.

The transmission/reception unit 511 transmits and receives information to and from external devices.

The management unit 512 manages the device 101 and the user terminal 102. When the management unit 512 acquires the position information, the identification information, and the instruction information of the device 101 from the control unit 507 of the device 101, the management unit 512 manages the position specified by the acquired position information as the position of the device 101 and manages each piece of the acquired information. Additionally, when the management unit 512 receives, from the user terminal 102, a request to be registered as a recipient of push notifications from the device 101, the management unit 512 manages the requested user terminal 102 as a target of the push notifications.

The control unit 513 transmits the position information and the instruction information of the device 101, acquired from the control unit 507 of the device 101, to the user terminal 102 that has received a beacon signal from the device 101. Additionally, upon receiving an instruction for push notification from the control unit 507 of the device 101, the control unit 513 sends a push notification to the user terminal 102 that is a target of the instruction.

FIG. 3C is a diagram illustrating a functional configuration of the user terminal 102. The user terminal 102 includes a transmission/reception unit 521, an operation reception unit 522, a position management unit 523, and a control unit 524.

The transmission/reception unit 521 transmits and receives information to and from external devices.

The operation reception unit 522 receives an operation performed by a user on the user terminal 102.

The position management unit 523 manages the position of the device 101. When the transmission/reception unit 521 receives a beacon signal from the device 101, the position management unit 523 transmits identification information of the device 101 included in the received beacon signal to the control unit 513 of the server device 103. Thereafter, the position management unit 523 receives position information and instruction information associated with the transmitted identification information from the control unit 513, and manages the position specified by the received position information as the position of the device 101.

The control unit 524 requests the device 101 to send a push notification, in accordance with the instruction indicated by the instruction information acquired by the position management unit 523. Additionally, the control unit 524 manages application software including the PWA. For example, in a case in which an operation by the user instructing installation of the PWA in the web browser is received by the operation reception unit 522, the control unit 524 installs the PWA. In this case, the control unit 524 holds information such as an icon image of the PWA and a URL as a connection destination. Additionally, in a case in which a push notification from the server device 103 is received by the transmission/reception unit 521, the control unit 524 causes the input/output device 308 to display the content of the received push notification. Additionally, the control unit 524 activates the PWA in response to an operation on the user terminal 102 performed by the user and in response to an instruction from the device 101.

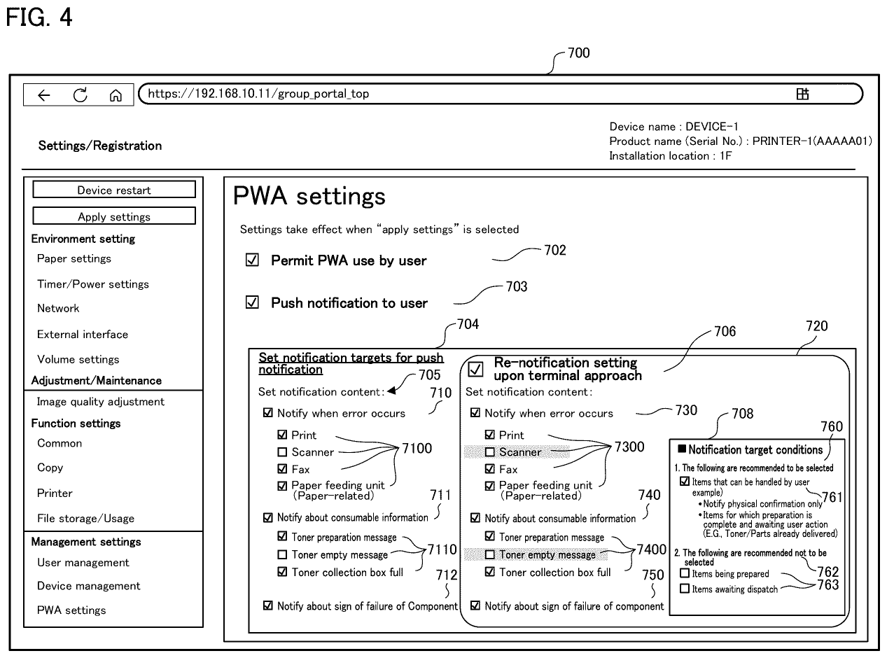

FIG. 4 is a diagram illustrating a reception screen 700. The reception screen 700 is a screen for receiving settings related to the PWA. In the present embodiment, the control unit 507 of the device 101 causes the input/output device 210 of the device 101 to display the reception screen 700. However, the control unit 507 may cause a device other than the device 101 to display the reception screen 700, such as a terminal used by an administrator of the function providing system 1.

The reception screen 700 shows a use reception portion 702, a notification reception portion 703, and a setting reception image 704.

The use reception portion 702 receives the use of the PWA by the user terminal 102. When the use reception portion 702 is selected by the administrator, use of the PWA by the user terminal 102 becomes possible.

The notification reception portion 703 receives the use of push notification from the device 101 to the user terminal 102. When the notification reception portion 703 is selected by the administrator, push notification from the device 101 to the user terminal 102 becomes possible.

The setting reception image 704 receives settings related to push notification in a case in which the notification reception portion 703 is selected. The setting reception image 704 shows an initial notification reception image 705 and a re-notification reception image 720.

The initial notification reception image 705 receives a setting related to an initial push notification (first push notification) performed in response to the detection of a detection state occurrence by the detection unit 505. Hereinafter, the initial push notification performed in response to the detection of the occurrence of the detection state by the detection unit 505 may be referred to as an “initial push notification.” The initial notification reception image 705 includes an error notification reception portion 710, a function reception portion 7100, a consumption notification reception portion 711, a consumption state reception portion 7110, and a sign notification reception portion 712.

The error notification reception portion 710 receives the occurrence of an error in the device 101 as a target of an initial push notification. When the error notification reception portion 710 is selected by the administrator, in a case in which an error occurs in the device 101, an initial push notification from the device 101 to the user terminal 102 is performed.

The function reception portion 7100 receives the occurrence of an error in a specific function in the device 101 as a target of the initial push notification. When the function reception portion 7100 is selected by the administrator, in a case in which an error occurs in a function that is a target of the selected function reception portion 7100, an initial push notification from the device 101 to the user terminal 102 is performed. In the illustrated example, four function reception portions 7100 are displayed. Functions targeted by the four function reception portions 7100 are “print,” “scanner,” “facsimile,” and “paper feeding unit (paper-related).” In the illustrated example, the function reception portions 7100 of “print,” “facsimile,” and “paper feeding unit (paper-related)” are selected, whereas the function reception portion 7100 of “scanner” is not selected.

Note that each time the error notification reception portion 710 is selected, selection and cancellation of selection of all of the function reception portions 7100 are alternately repeated.

The consumption notification reception portion 711 receives the occurrence of a specific state related to a consumable of the device 101 as a target of the initial push notification. When the consumption notification reception portion 711 is selected, in a case in which a specific state related to a consumable of the device 101 occurs, an initial push notification from the device 101 to the user terminal 102 is performed.

The consumption state reception portion 7110 receives the occurrence of a specific state in a component related to a consumable of the device 101 as a target of the initial push notification. When the consumption state reception portion 7110 is selected by the administrator, in a case in which a specific state occurs in a component that is a target of the selected consumable state reception portion 7110, the initial push notification from the device 101 to the user terminal 102 is performed. In the illustrated example, three consumption state reception portions 7110 are displayed. A first consumption state reception portion 7110 receives an initial push notification in a case in which a state in which the remaining amount of toner in the toner bottle has been reduced to a predetermined amount occurs. The predetermined amount may be any amount. For example, the predetermined amount may be one-half of the full amount. A second consumption state reception portion 7110 receives an initial push notification in a case in which the toner in the toner bottle has become empty. A third consumption state reception portion 7110 receives an initial push notification in a case in which a toner box for collecting used toner becomes full of toner. In the illustrated example, the consumption state reception portion 7110 that receives the occurrence of a state in which the remaining amount of toner has decreased to a predetermined amount and the consumable state reception portion 7110 that receives the occurrence of a state in which the toner in the toner bottle is empty are selected. In contrast, the consumption state reception portion 7110 that targets the occurrence of a state in which the toner box is full of toner is not selected.

Note that each time the consumables notification reception portion 711 is selected, selection and cancellation of selection of all of the consumption state reception portions 7110 are alternately repeated.

The sign notification reception portion 712 receives, as a target of the initial push notification, the occurrence of a state in which a sign of failure of a component in the device 101 has been detected. When the sign notification reception portion 712 is selected, in a case in which a state in which a sign of failure is detected occurs in a detection unit (not illustrated) that detects a sign of failure of a component in the device 101, an initial push notification from the device 101 to the user terminal 102 is performed.

The re-notification reception image 720 receives a setting related to a push notification that is performed again after the initial push notification is performed. Note that hereinafter, a push notification that is performed again after the initial push notification may be referred to as a “re-push notification” (second push notification). In the re-notification reception image 720, an error notification reception portion 730, a function reception portion 7300, a consumption notification reception portion 740, a consumption state reception portion 7400, a sign notification reception portion 750, and a recommendation image 708 are displayed.

The error notification reception portion 730 receives occurrence of an error in the device 101 as a target of a re-push notification. When the error notification reception portion 730 is selected by the administrator, in a case in which an error occurs in the device 101, a re-push notification is performed from the device 101 to the user terminal 102.

The function reception portion 7300 receives the occurrence of an error in a specific function in the device 101 as a target of a re-push notification. When the function reception portion 7300 is selected by the administrator, in a case in which an error occurs with respect to the function that is the target of the selected function reception portion 7300, a re-push notification is performed from the device 101 to the user terminal 102. In the illustrated example, four function reception portions 7300 are displayed. The targets of the functions in the four function reception portions 7300 are “print”, “scanner”, “facsimile”, and “paper feeding unit (paper-related)”. In the illustrated example, the function reception portions 7300 of “print”, “facsimile”, and “paper feeding unit (paper-related)” are selected, while the function reception portion 7300 of “scanner” is not selected.

In the present embodiment, selection of the function reception portion 7300 is possible only for an error in the same functions as those received by the function reception portion 7100 as targets of push notification. That is, for an error in a function that is not received by the function reception portion 7100 as a target of push notification, selection of the function reception portion 7300 is not received. As an example, since the function reception portion 7100 of “print” is selected, selection of the function reception portion 7300 of “print” is received. In contrast, since the function reception portion 7100 of “scanner” is not selected, selection of the function reception portion 7300 of “scanner” is not received. Additionally, the function reception portion 7300 for which selection is not received, such as the function reception portion 7300 of “scanner”, is displayed in a color (gray in the illustrated example) different from that of the function reception portion 7300 for which selection is received.

Additionally, in the present embodiment, each time the error notification reception portion 730 is selected, selection and cancellation of selection of all the function reception portion 7300 for which selection is received are alternately repeated.

The consumables notification reception portion 740 receives occurrence of a specific state related to a consumables of the device 101 as a target of a re-push notification. When the consumables notification reception portion 740 is selected, in a case in which a specific state related to a consumable of the device 101 has occurred, a re-push notification is sent from the device 101 to the user terminal 102.

The consumption state reception portion 7400 receives occurrence of a specific state in a component related to a consumable of the device 101 as a target of re-push notification. When the administrator selects the consumption state reception portion 7400, a re-push notification from the device 101 to the user terminal 102 is performed in a case in which a specific state in a component that is a target of the selected consumable state reception portion 7400 occurs. In the illustrated example, three consumption state reception portions 7400 are displayed. The first consumption state reception portion 7400 receives a re-push notification in a case in which a state in which the remaining amount of toner in the toner bottle has decreased to a predetermined amount occurs. The predetermined amount may be any amount. For example, the predetermined amount may be one-half of the full amount. The second consumption state reception portion 7400 receives a re-push notification in a case in which the toner in the toner bottle becomes empty. The third consumption state reception portion 7400 receives a re-push notification in a case in which a toner box for collecting used toner becomes full of toner. In the illustrated example, the consumption state reception portion 7400 that targets the occurrence of a state in which a remaining amount of toner has decreased to a predetermined amount, and the consumption state reception portion 7400 that targets occurrence of a state in which the toner in a toner bottle is empty, are selected. In contrast, the consumption state reception portion 7400 that targets the occurrence of a state in which the toner box is full of toner is not selected.

In the present embodiment, the selection of the consumption state reception portion 7400 is possible only for a state that is the same as the state received by the consumption state reception portion 7110 as a target of push notification. That is, for a state that is not received by the consumption state reception portion 7110 as a target of push notification, the selection of the consumption state reception portion 7400 is not received. Additionally, the consumption state reception portion 7400, selection of which is not received, is displayed in a color (gray in the illustrated example) different from that of the consumption state reception portion 7400, selection of which is received.

Additionally, in the present embodiment, each time the consumption notification reception portion 740 is selected, selection and cancellation of selection of all the consumption state reception portions 7400, selection of which is accepted, are alternately repeated.

The sign notification reception portion 750 receives, as a target of a re-push notification, occurrence of a state in which a sign of failure of a component in the device 101 is detected. When the sign notification reception portion 750 is selected, a re-push notification is performed from the device 101 to the user terminal 102 in a case in which a state in which a sign of failure of a component in the device 101 is detected by a detection unit (not illustrated) occurs.

In the present embodiment, the selection of the sign notification reception portion 750 is received only in a case in which the sign notification reception portion 712 is selected.

For each state of the device 101, the recommendation image 708 recommends that the state be set as a target of a re-push notification and recommends that the state not be set as a target of a re-push notification. In the recommendation image 708, a selection recommendation image 760, a recommendation reception portion 761, a non-selection recommendation image 762, and a non-recommendation reception portion 763 are displayed.

The selection recommendation image 760 recommends that the state shown in the recommendation reception portion 761 be received as a target of the re-push notification. That is, the selection recommendation image 760 recommends selecting the recommendation reception portion 761. In the illustrated example, the text “The following are recommended to be selected” is shown in the selection recommendation image 760.

The recommendation reception portion 761 receives, as a target of the re-push notification, occurrence of a state recommended as a target of a re-push notification. When the recommendation reception portion 761 is selected by the administrator, a re-push notification from the device 101 to the user terminal 102 is performed in a case in which the state that is a target of the selected recommendation reception portion 761 occurs. In the illustrated example, in the recommendation reception portion 761, the text “Items that can be handled by user,” which indicates a state that becomes a target of the re-push notification by being selected is displayed. Additionally, in the recommendation reception portion 761, texts such as “Notify physical confirmation only” and “Items for which preparation is complete and awaiting user action (toner/parts delivered, and the like.)” are shown, as examples of states that become targets of re-push notification by being selected.

The non-selection recommendation image 762 recommends not setting the state shown in the non-recommendation reception portion 763 as a target of a re-push notification. That is, the non-selection recommendation image 762 recommends not selecting the non-recommendation reception portion 763. In the illustrated example, the text “The following are recommended not to be selected.” is shown in the non-selection recommendation image 762.

The non-recommendation reception portion 763 receives, as a target of the re-push notification, occurrence of a state recommended not to be a target of the re-push notification. When the non-recommendation reception portion 763 is selected by the administrator, in a case in which a state that is a target of the selected recommendation reception portion 761 occurs, a re-push notification is performed from the device 101 to the user terminal 102. In the illustrated example, two non-recommendation reception portions 763 are displayed. The first non-recommendation reception portion 763 receives, as a target of the re-push notification, occurrence of a state in which preparation for response is in progress, that is, a state in which preparation for response has not been completed. The second non-recommendation reception portion 763 receives, as a target of the re-push notification, occurrence of a state in which a person responsible for repairing the device 101 is planning to depart for the installation location of the device 101.

Note that the state in which selection as a target of the initial push notification or as a target of the re-push notification is received in the setting reception image 704 is determined according to the type of the device 101, such as a network router, a monitoring camera, a digital medical device, an automobile, a home delivery box, a locker, and the like.

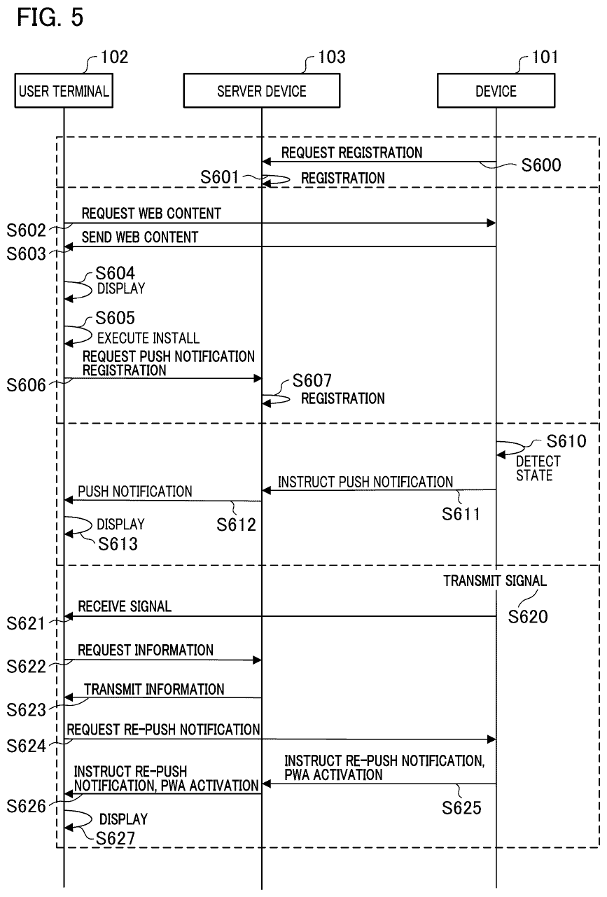

FIG. 5 is a sequence diagram illustrating a flow of processing performed by the device 101, the user terminal 102, and the server device 103.

The processes in steps (hereinafter sometimes referred to as “S”) 600 to 601 in FIG. 5 relate to the registration of the position of the device 101 by the server device 103. Additionally, the processes in steps 602 to 607 in FIG. 5 are processes relating to registration of the user terminal 102 as a target of push notification by the server device 103. Additionally, the processes in steps 610 to 613 in FIG. 5 are processes regarding the initial push notification. Additionally, the processes in steps 620 to 627 in FIG. 5 are processes regarding the re-push notification.

First, processing regarding registration of the position of the device 101 by the server device 103 will be explained.

The control unit 507 of the device 101 transmits position information, identification information, and instruction information to the server device 103, and requests the server device 103 to register the position of the device 101 (S600).

The management unit 512 of the server device 103 acquires the position information, identification information, and instruction information transmitted from the device 101 via the transmission/reception unit 511. Subsequently, the management unit 512 registers the position specified based on the acquired position information as the position of the device 101 specified based on the acquired identification information (S601). Additionally, the management unit 512 manages each piece of the acquired information.

Next, processing related to registration of the user terminal 102 as a target of push notification by the server device 103 will be explained.

The user inputs, into the user terminal 102, the URL of the website that is used for installation of the PWA. In this case, the control unit 524 of the user terminal 102 sends a request to the device 101 for web contents to be displayed on the web browser of the user terminal 102 (S602).

The control unit 507 of the device 101 transmits the web contents in response to the request from the user terminal 102 (S603).

The control unit 524 of the user terminal 102 displays the web contents transmitted from the device 101 on the input/output device 308 (S604). At this time, the web contents displayed on the input/output device 308 include UI information and PWA information. The UI information (terminal site) is composed of, for example, HTML, JavaScript, and CSS. The PWA information includes Service Worker and a manifest file, which are components of the PWA. The manifest file is a file describing installation settings of the PWA. Additionally, the PWA information may include a beacon reception function. The beacon reception function is a function for receiving a beacon signal transmitted from the device 101. The user terminal 102, by including a beacon reception function, receives a beacon signal transmitted from the device 101, and transmits identification information included in the received beacon signal to the server device 103, thereby requesting position information of the device 101 specified by the identification information. In a case in which the beacon reception function is included in the PWA information, it becomes unnecessary for the user terminal 102 to install a native application for receiving the beacon signal. Accordingly, the burden on the user associated with performing setting operations on the user terminal 102 for receiving re-push notifications is reduced. The beacon reception function may be included in the PWA information as a partial function of Service Worker operating in a background process of the user terminal 102 or may be included as a background process that is different from Service Worker.

When the user instructs installation of the PWA by operating the user terminal 102, the control unit 524 of the user terminal 102 executes installation of the PWA (S605).

The control unit 524 of the user terminal 102 requests the server device 103 to register the user terminal 102, as a target of push notifications from the device 101, based on the manifest file (S606).

Upon receiving a request from the user terminal 102, the management unit 512 of the server device 103 registers the user terminal 102 as a target of push notifications from the device 101, thereby managing the user terminal 102 as a target of push notifications (S607).

It should be noted that, in the case of transmitting a request for push notification registration to the server device 103, the control unit 524 of the user terminal 102 may transmit information for identifying the user who is a target of the registration. The management unit 512 of the server device 103 may register, as a target of push notification, only the user for whom a registration request has been received from the user terminal 102. In this case, when the user who has been registered as the target of push notification is logged in to the user terminal 102, the push notification to the user terminal 102 is performed. In contrast, when a user who has not been registered as the target of push notification is logged in to the user terminal 102, the push notification to the user terminal 102 is not performed. Additionally, the control unit 524 of the user terminal 102 may determine whether or not the logged-in user is the target of push notification.

Additionally, the push notification to the user terminal 102 may be performed regardless of the user who is logged in to the user terminal 102. In this case, when a user who has not been registered as a target of the push notification is logged in to the user terminal 102, the control unit 524 may not cause the content of the push notification to be displayed on the user terminal 102. Then, when the user who has been registered as the target of push notification is logged in to the user terminal 102, the control unit 524 may cause the content of the push notification to be displayed on the user terminal 102.

Next, a process regarding an initial push notification will be explained.

When a state of the device 101, the state having been predetermined as a detection target by the detection unit 505 of the device 101, occurs, the detection unit 505 detects the state having occurred in the device 101 (S610). Hereinafter, it is assumed that the state detected by the detection unit 505 is set on the reception screen 700 as a state targeted by the initial push notification.

The control unit 507 of the device 101 transmits an instruction for a push notification to the server device 103, together with information indicating the content of the push notification (S611).

Upon receiving the instruction from the device 101, the control unit 513 of the server device 103 performs a push notification to the user terminal 102 registered in the management unit 512, as a target of push notification, based on the content of the instruction received from the device 101 (S612). That is, the control unit 513 transfers the push notification received from the device 101 to the user terminal 102.

When a push notification is received via the transmission/reception unit 521, Service Worker that is operating in the background by the control unit 524 of the user terminal 102 causes the content of the received push notification to be displayed on the input/output device 308 (S613).

Next, a process related to a re-push notification will be explained. Hereinafter, it is assumed that the state detected in step 610 is set on the reception screen 700, as a state that is a target of a re-push notification. Additionally, it is assumed that the state detected in step 610 continues until the re-push notification is performed.

After the initial push notification is performed, the transmission/reception unit 501 of the device 101 transmits a beacon signal to the surroundings (S620). This beacon signal is not received by the user terminal 102 located far from the device 101, while the beacon signal is received by the user terminal 102 located near the device 101. Additionally, the transmission/reception unit 501 continuously transmits the beacon signal.

When the user approaches the device 101, the transmission/reception unit 521 of the user terminal 102 carried by the user receives the beacon signal (S621). The position management unit 523 of the user terminal 102 transmits, to the server device 103, identification information of the device 101 included in the beacon signal received by the transmission/reception unit 521, thereby requesting position information of the device 101 specified by the identification information (S622).

When the control unit 513 of the server device 103 acquires the identification information from the user terminal 102 via the transmission/reception unit 511, the control unit 513 transmits the position information and instruction information of the device 101 specified by the acquired identification information to the user terminal 102 (S623).

When the control unit 524 of the user terminal 102 acquires the position information and the instruction information via the transmission/reception unit 521, the control unit 524 requests the device 101 located at a position specified based on the position information, to perform a re-push notification based on the instruction specified from the instruction information (S624).

Upon receiving a request for a re-push notification from the user terminal 102, the control unit 507 of the device 101 transmits, to the server device 103, an instruction for the re-push notification and an instruction for causing activation of the PWA, together with information for identifying the user terminal 102 having transmitted the request (S625).

Upon receiving the instruction from the device 101, the control unit 513 of the server device 103 transmits a re-push notification and an instruction for causing activation of the PWA to the user terminal 102 that has requested the re-push notification to the device 101 (S626).

When Service Worker that is operated in the background by the control unit 524 of the user terminal 102 receives the re-push notification via the transmission/reception unit 521, Service Worker causes the input/output device 308 to display the content of the received push notification. Additionally, in the case in which the PWA is not launched in the user terminal 102 at that time, the control unit 524 activates the PWA in response to the instruction from the server device 103 (S627).

Note that, although, in the example described above, it has been explained that the re-push notification from the device 101 is performed by the user terminal 102 communicating with the server device 103 (S622, S623) and thereafter requesting the device 101 to perform the re-push notification, the present invention is not limited thereto.

For example, when the user terminal 102 communicates with the server device 103 based on the reception of the beacon signal, the server device 103 may notify the device 101 that the beacon signal has been received by the user terminal 102. In this case, the device 101 may transmit an instruction for the re-push notification to the server device 103, together with information for identifying the user terminal 102 having transmitted the request, whereby the re-push notification may be performed.

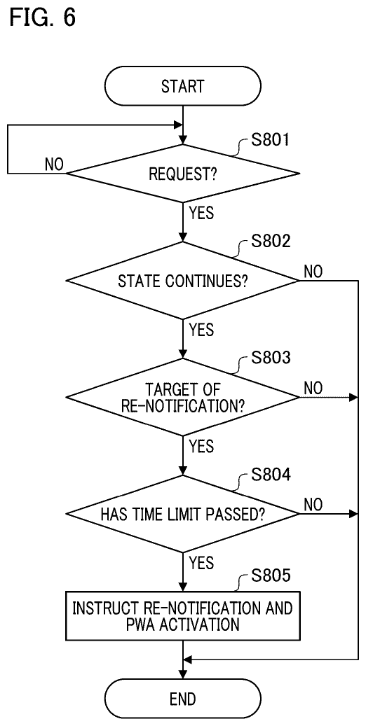

FIG. 6 is a flowchart illustrating a flow of a re-notification process. The re-notification process is a process in which the device 101 causes a re-push notification to be performed for the user terminal 102 to which the initial push notification has been sent. In the present embodiment, after the initial push notification is performed, when the device 101 transmits a beacon signal (refer to S620 in FIG. 5), the re-notification process is started.

The control unit 507 of the device 101 determines whether or not a request for re-push notification has been received from the user terminal 102 (S801). While a negative result continues (“No” in S801), the processing of step S801 is repeatedly performed.

Additionally, in a case in which a request for a re-push notification has been received from the user terminal 102 (“Yes” in S801), the control unit 507 determines whether or not the detection state that served as a trigger for the initial push notification is continuing (S802). The control unit 507 determines whether or not the detection state that served as a trigger for the initial push notification is continuing, based on the history of the state of the device 101 managed by the device management unit 502.

In a case in which the detection state that served as a trigger for the initial push notification is continuing (“Yes” in step S802), the process proceeds to the next step. The control unit 507 determines whether or not the detection state that served as a trigger for the initial push notification is set on the reception screen 700 as a state targeted for re-push notification (S803). The control unit 507 determines whether or not the detection state that served as a trigger for the initial push notification is set, on the reception screen 700, as a state targeted for re-push notification, based on whether or not the detection state is selected in the re-notification reception image 720 of the reception screen 700. In a case in which the detection state that served as a trigger for the initial push notification is set as the state targeted for re-push notification (“Yes” in step S803), the process proceeds to the next step. The control unit 507 determines whether or not a time limit has elapsed since performing the initial push notification or the re-push notification on the user terminal 102 (S804). The time limit is a period during which push notifications are restricted, the period being provided to suppress frequent push notifications from the device 101 to the user terminal 102. The time limit may be any duration, and may be, for example, five minutes.

In a case in which the time limit has elapsed since the initial push notification or the re-push notification is transmitted from the device 101 to the user terminal 102 (“Yes” in S804), the control unit 507 instructs the server device 103 to perform the re-push notification and to activate the PWA (S805). The process of step S805 is the same as the process of step S625 shown in FIG. 5. Accordingly, the server device 103 provides the re-push notification to the user terminal 102 and causes the PWA to be activated in the user terminal 102.

Additionally, there are cases in which the detection state does not continue (“No” in S802), there are cases in which the detection state is not set as a target for re-push notification (“No” in S803), or there are cases in which the time limit has not elapsed since the push notification has been performed (“No” in S804). In this case, the re-push notification is not performed, and the current re-notification process ends.

Note that in a case in which the detection state does not continue (“No” in S802), or in a case in which the detection state is not set as a state to be targeted for the re-push notification (“No” in S803), the control unit 507 completes the transmission of the beacon signal by the transmission/reception unit 501. However, in a case in which the detection state is not set as a state targeted for the re-push notification (“No” in S803), the control unit 507 may cause the transmission/reception unit 501 not to transmit the beacon signal after the initial push notification has been performed.

Additionally, in a case in which the time limit has not elapsed since the push notification has been performed (“No” in S804), the current re-notification process ends in a state in which transmission of the beacon signal by the transmission/reception unit 501 is continued. In such a case, the re-notification process is started again.

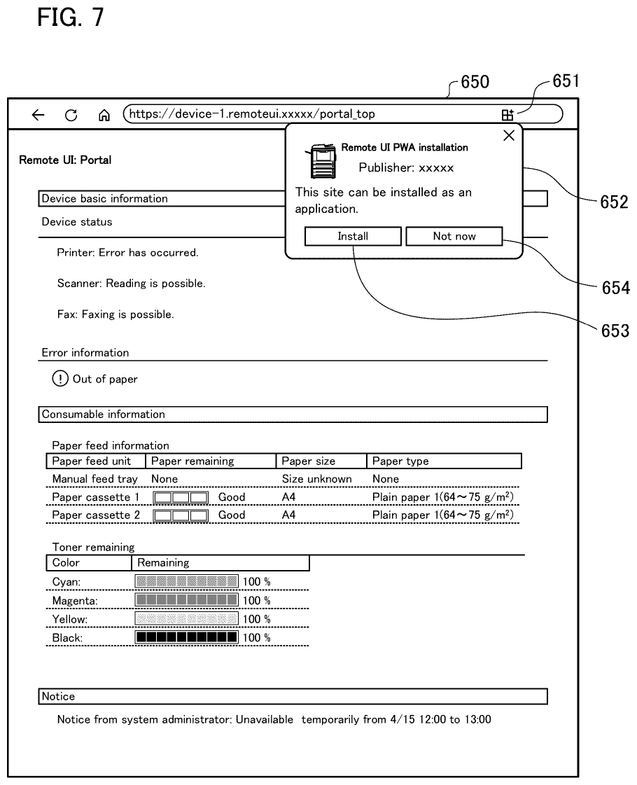

FIG. 7 is a diagram illustrating a screen 650 displayed on the input/output device 308 in step 604 of FIG. 5. A button 651 is displayed in a case in which the terminal site displayed on the input/output device 308 can be installed as a PWA. A dialog 652 is displayed to the user for confirming whether or not to install the PWA. Note that the dialog 652 may be displayed in response to the button 651 being pressed by the user. A button 653 is pressed by the user in a case of installing the PWA. When the button 653 is pressed, the PWA is installed in the user terminal 102.

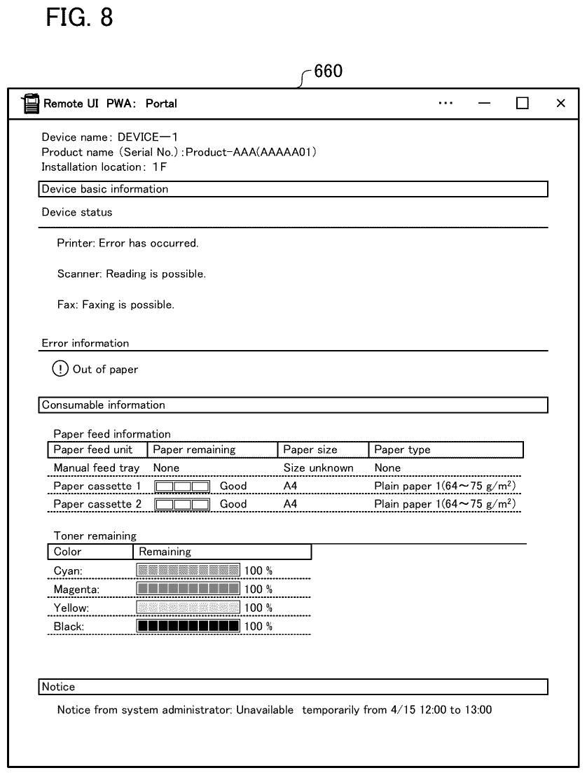

FIG. 8 is an example of a screen 660 of a remote UI (terminal site) displayed on the input/output device 308 by the PWA in a case in which the PWA is installed in the user terminal 102. Although the display content of the screen 660 shown in FIG. 8 is equivalent to that displayed on the screen 650 shown in FIG. 7, the display differs from that of a normal web browser, for example, in that an address bar is not displayed, and the display is such that it appears as if a native application is being operated. Note that, even in a case in which the user starts the installed PWA, the screen 660 shown in FIG. 8 is displayed on the input/output device 308 of the user terminal 102.

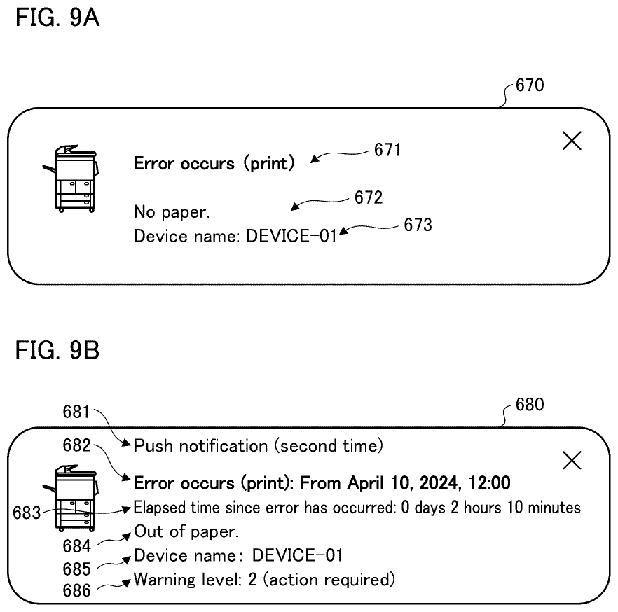

FIG. 9A is a diagram illustrating an initial notification image 670. The initial notification image 670 is an image that is displayed on the input/output device 308 of the user terminal 102 in a case in which the initial push notification is performed. That is, the initial notification image 670 is content that is notified to the user terminal 102 as the initial push notification. In the initial notification image 670, a type notification portion 671, a content notification portion 672, and a device notification portion 673 are displayed.

In the type notification portion 671, the text “Error Occurs”, which indicates a type of a state that has occurred in the device 101, and the text “Print”, which indicates a type of a function that is a target of the occurred state are displayed.

In the content notification portion 672, the content of the state that has occurred in the device 101 is displayed. In the illustrated example, in the content notification portion 672, the text “Out of Paper” is displayed.

In the device notification portion 673, information for identifying the device 101 is displayed.

FIG. 9B is a diagram showing a re-notification image 680. The re-notification image 680 is an image displayed on the input/output device 308 of the user terminal 102 in a case in which the re-push notification is performed. That is, the re-notification image 680 is content that is notified to the user terminal 102 as the re-push notification. In the re-notification image 680, a number-of-times image 681, a type notification portion 682, a period notification portion 683, a content notification portion 684, a device notification portion 685, and a warning level notification portion 686 are displayed.

In the number-of-times image 681, the number of times of push notifications performed for the user terminal 102 due to the occurrence of one detection state is displayed. In the illustrated example, in the number-of-times image 681, the text “Second Time” indicating that the number of times of push notifications is two is displayed.

In the type notification portion 682, the text “Error Occurs,” which is a type of state that has occurred in the device 101, and the text “Print,” which is a type of function that is a target of the occurred state, are displayed. Additionally, in the type notification portion 682, the text “From 12:00 on Apr. 10, 2024,” which indicates a start time of the detection state which triggers the re-push notification, is displayed.

The period notification portion 683 indicates a period that has elapsed since the occurrence of the detection state that served as a trigger for the re-push notification. In the illustrated example, the text “0 days 2 hours 10 minutes” is displayed in the period notification portion 683.

The contents of the content notification portion 684 and the device notification portion 685 are the same as those of the content notification portion 672 and the device notification portion 673 of the initial notification image 670.

In the warning level notification portion 686, a warning level by the push notification is displayed. In the present embodiment, the warning level by the push notification is set to any one of 1 to 3 according to the number of times of push notifications performed for the user terminal 102 due to the occurrence of one detection state. Additionally, as the number of push notifications increases, the warning level increases, and as the numerical value of the warning level is higher, the level of warning is higher. In the illustrated example, the text “Warning Level: 2 (Action Required)” is displayed in the warning level notification portion 686.

Note that, although in the present embodiment, the contents displayed on the user terminal 102 are different between the initial push notification and the re-push notification, the present invention is not limited thereto. Even in a case in which the initial push notification is executed, content identical to the re-notification image 680 may be displayed on the user terminal 102. Additionally, even in a case in which the re-push notification is executed, content identical to the initial notification image 670 may be displayed on the user terminal 102.

As described above, in the present embodiment, in a case in which the device 101 is in a state that satisfies a predetermined state condition, the control unit 507 of the device 101 causes a push notification to be performed for the user terminal 102 in which software as the PWA for providing information regarding the state has been installed. Examples of the state condition include that a state of the device 101 that is a target of the push notification is detected by the detection unit 505. Additionally, the state of the device 101 that satisfies the state condition includes, for example, a state selected in the initial notification reception image 705 (refer to FIG. 4). Then, after a push notification to the user terminal 102 has been performed, in a case in which the user terminal 102 is located within a range that satisfies a predetermined range condition with respect to the device 101, the control unit 507 causes a push notification to be sent again to the user terminal 102. For example, a range condition includes the recognition that the user terminal 102 has approached device 101. Additionally, examples of the range that satisfies the range condition include a range in which the user terminal 102 is capable of receiving a beacon signal.

In this case, it is not necessary to set the notification in the user terminal 102 as in a case in which the notification from the device 101 to the user terminal 102 is performed by application software such as a native application. Accordingly, it is possible to cause a user, who has approached the device 101 having a requirement for notification to the user terminal 102, to recognize the presence of the device 101, without requiring notification settings for each user terminal 102.

Additionally, in a case in which the control unit 507 causes a push notification to be sent again to the user terminal 102, in a case in which the user terminal 102 is not activating software as a PWA, the control unit 507 causes the software as the PWA to be activated in the user terminal 102.

In this case, in a case in which the re-push notification is performed, it becomes unnecessary for the user to perform an operation for activating the PWA separately from an operation for confirming the content of the re-push notification.

Note that the control unit 507 may cause the software as the PWA to be activated in the user terminal 102, provided that a predetermined operation by the user has been performed on the user terminal 102, in a case in which a re-push notification is to be performed. Examples of the predetermined operation include an operation in which the user selects the re-notification image 680 (refer to FIG. 9B). Additionally, the predetermined operation may be an operation in which the user instructs activation of the PWA on an activation reception screen (not illustrated) displayed on the user terminal 102 in a case in which the re-push notification is performed.

In this case, activation of the PWA against the intention of the user is suppressed.

Additionally, in a case in which the PWA is launched according to the re-push notification, a terminal site cached within the user terminal 102 or a terminal site provided by the device 101 is displayed on the user terminal 102. Additionally, in a case in which the PWA of the terminal site is operating in the background at the time when the re-push notification is performed, the screen 660 may be displayed on the top screen of the user terminal 102, and the re-notification image 680 may be displayed in front of the screen 660. Whether or not to perform display by the PWA during such background operation may be uniformly set in the device 101 by an administrator or may be set for each user terminal 102. Whether or not the display by the PWA during background operation is to be performed may be determined according to the content of the push notification.

Additionally, in the present embodiment, the state condition includes a first state condition and a second state condition that is different from the first state condition. Examples of the first state condition include that the state of the device 101, which is the target of the re-push notification, is detected by the detection unit 505. Additionally, examples of the second state condition include that the state of the device 101, which is the target of the initial push notification instead of the re-push notification, is detected by the detection unit 505. Then, in a case in which the device 101 is in a state that satisfies the first state condition, the control unit 507 causes a re-push notification to be performed for the user terminal 102 located at a position that satisfies the range condition. Additionally, in a case in which the device 101 is in a state satisfying the second state condition, the control unit 507 restricts the re-push notification to the user terminal 102 located at a position satisfying the range condition.

In this case, whether or not the re-push notification is to be performed after the initial push notification can be switched according to a state occurring in the device 101.

In particular, in the present embodiment, the control unit 507 displays the reception screen 700 for receiving a selection of which state is to be set as the state satisfying the first state condition (refer to FIG. 4). On the reception screen 700, information recommending that a specific state be selected as the state satisfying the first state condition is displayed. Examples of the information recommending that the specific state be selected as the state satisfying the first state condition include the selection recommendation image 760 and the recommendation reception portion 761. Additionally, the specific state includes a state that is received as a target of the re-push notification by the selection of the recommendation reception portion 761.

In this case, it is possible to prompt selection of a specific state as a state of the device 101 in which forgetfulness by the user is less likely to occur due to the re-push notification.

Additionally, there may be a case in which the user terminal 102 is located within a range satisfying the range condition after the push notification to the user terminal 102 has been performed. In this case, in a case in which the device 101 is in a state that does not satisfy the state condition (“No” in S802 of FIG. 6), the control unit 507 restricts the re-push notification to the user terminal 102.

In this case, even though the device 101 is not in a state that is a target of the re-push notification, the re-push notification is prevented from being performed.

Additionally, the control unit 507 restricts re-push notification to the user terminal 102 even in a case in which the user terminal 102 is located within a range satisfying the range condition, in a case in which a predetermined time has not elapsed after the push notification to the user terminal 102 has been performed. Examples of the predetermined time include a time limit.

In this case, as compared to a configuration in which the re-push notification is performed regardless of the elapsed time since the push notification to the user terminal 102 has been performed, the frequency of the push notifications can be suppressed, whereby complexity in confirmation of the push notifications by the user can be suppressed.

Additionally, the information to be re-push-notified includes information regarding a start time at which the device 101 has entered a state satisfying the state condition, information in accordance with an elapsed time since the device 101 has entered the state satisfying the state condition, and information in accordance with a number of times the push notification has been performed for the user terminal 102. The type notification portion 682 exemplifies information regarding a start time at which device 101 has entered a state satisfying the state condition. Additionally, as information in accordance with the elapsed time since the device 101 has entered a state satisfying the state condition, the period notification portion 683 and the warning level notification portion 686 may be exemplified. Additionally, as information in accordance with the number of times the push notification has been performed for the user terminal 102, the number-of-times image 681 and the warning level notification portion 686 may be exemplified.

Here, the information to be re-push-notified may include at least one of the pieces of information described above. Even in this case, it is possible to allow the user to recognize the state that has occurred in the device 101.

### Second Embodiment

Next, the function providing system 1 according to the second embodiment will be explained. The first embodiment and the second embodiment are shared in that the user terminal 102 requests the device 101 to perform a re-push notification based on reception of a beacon signal, and that the re-push notification is performed from the device 101 to the user terminal 102. In contrast, in the first embodiment, the approach of the user terminal 102 to the device 101 is detected based on reception of the beacon signal transmitted from the device 101 by the user terminal 102, and the re-push notification is performed based on this detection. In contrast, in the second embodiment, the approach of the user terminal 102 to the device 101 is detected in stages, and a re-push notification from the device 101 to the user terminal 102 is performed at each stage at which the approach is detected. Examples of the staged approach of the user terminal 102 to the device 101 include approach to a building in which the device 101 is installed, approach to the same floor as the device 101 within the building, and approach to the same room as the device 101 within the building.

Note that, in the second embodiment, a configuration of the function providing system 1 that differs from that of the first embodiment will be explained, and explanation of the configuration of the function providing system 1 that is the same as that of the first embodiment will be omitted.

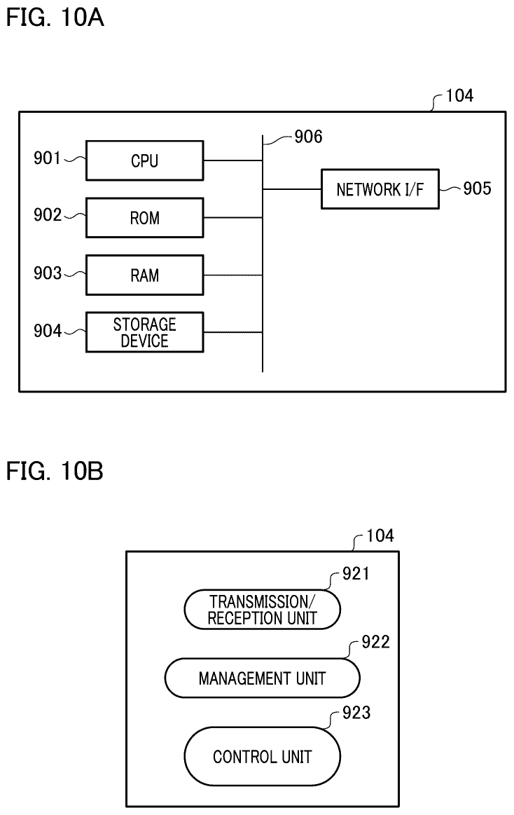

FIG. 10A is a diagram illustrating a hardware configuration of a transmitter 104 provided in the function providing system 1 according to the second embodiment. The transmitter 104 is a transmitter of a beacon signal. That is, in the present embodiment, it is the transmitter 104, rather than the device 101, that transmits the beacon signal. The transmitter 104 is provided at each of the entrances of a building in which the device 101 is installed, an entrance of a floor in the building in which the device 101 is installed, and an entrance of a room in the building in which the device 101 is installed. That is, the transmitter 104 is provided for each stage of detecting the approach of the user terminal 102 to the device 101. Additionally, the transmitter 104 is connected to the device 101, the user terminal 102, and the server device 103 via the network 100.

As shown in FIG. 10A, the transmitter 104 includes a CPU 901, a ROM 902, a RAM 903, a storage device 904, and a network I/F 905. The CPU 901, the ROM 902, the RAM 903, the storage device 904, and the network I/F 905 are connected to one another via a bus 906.

The CPU 901 controls the entirety of the transmitter 104 by executing a program stored in the ROM 902. The ROM 902 stores the above-described program, position information indicating a position of the transmitter 104, and the like. The RAM 903 functions as a work area or a memory of the CPU 901, and stores information indicating settings in the transmitter 104, various logs, and the like. The network I/F 905 communicates with an external device via the network 100. The CPU 901 executes the program together with the ROM 902 and the RAM 903 and performs processing for recording information in a recording medium such as the storage device 904. The storage device 904 functions as an external storage device, and is capable of storing information indicating settings in the transmitter 104, various logs, and the like, instead of the RAM 903.

FIG. 10B is a diagram illustrating a functional configuration of the transmitter 104. The transmitter 104 includes a transmission/reception unit 921, a management unit 922, and a control unit 923.

The transmission/reception unit 921 transmits and receives information to and from an external device. The transmission/reception unit 921 also transmits a beacon signal to the surroundings.

The management unit 922 manages information generated in the transmitter 104 and information acquired by the transmitter 104. The management unit 922 manages, for example, position information indicating a position of the transmitter 104, identification information identifying the transmitter 104, a firmware version, network information such as an IP address, and information for communicating with the server device 103. Additionally, an operation history of the transmitter 104, including an error history, may also be managed by the management unit 922.

The control unit 923 requests the server device 103 to register the position of the transmitter 104 by transmitting to the server device 103 position information and identification information managed by the management unit 922 in association with each other. Additionally, the control unit 923 includes, in a beacon signal transmitted by the transmission/reception unit 921, position information of the transmitter 104 that is managed by the management unit 922.

Note that the control unit 923 may have a function as an application server. In this case, the control unit 923 may provide a website screen to the user terminal 102 and may receive, on the provided website screen, an instruction from the user to register the transmitter 104 in the server device 103. For example, when an IP address of the server device 103 is input by the user on a website screen displayed on the user terminal 102, the control unit 923 communicates with the server device 103 and requests the server device 103 to register the transmitter 104.

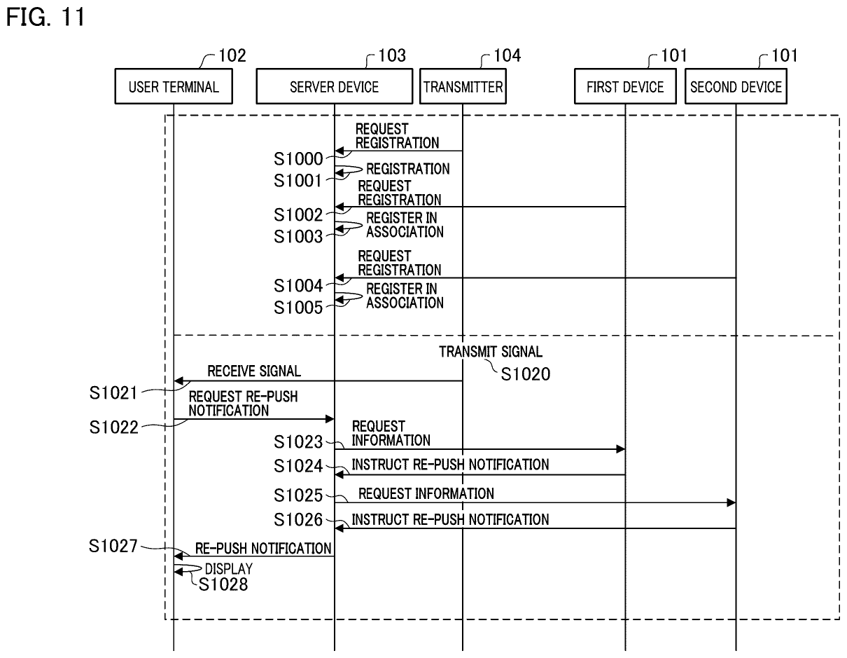

FIG. 11 is a sequence diagram illustrating a flow of processes performed by the device 101, the user terminal 102, the server device 103, and the transmitter 104. Hereinafter, it is assumed that two devices 101, comprising a first device 101 and a second device 101, are provided in the function providing system 1.

The processes in steps 1000 to 1005 of FIG. 11 relate to processing for registration of the transmitter 104 and the device 101 by the server device 103. Additionally, the processes in steps 1020 to 1028 of FIG. 11 relate to processing related to the re-push notification. Note that the processing related to registration of the user terminal 102 as a target of push notification by the server device 103 and the processing related to the initial push notification in the present embodiment are the same as those in the first embodiment, and therefore, explanation thereof will be omitted.

First, a process related to registration of the transmitter 104 and the device 101 by the server device 103 will be explained.

The control unit 923 of the transmitter 104 transmits position information and identification information to the server device 103 and requests the server device 103 to register the position of the transmitter 104 (S1000).

When the management unit 512 of the server device 103 acquires position information and identification information transmitted from the transmitter 104 via the transmission/reception unit 511, the management unit 512 registers the position specified by the acquired position information as the position of the transmitter 104 specified by the acquired identification information (S1001). Additionally, the management unit 512 manages each piece of the acquired information.

Note that the processes in steps S1000 and S1001 are performed for each transmitter 104.

Next, the control unit 507 of the first device 101 transmits identification information to the server device 103 and requests the server device 103 to register the device 101 (S1002). When the management unit 512 of the server device 103 acquires identification information transmitted from the first device 101 via the transmission/reception unit 511, the management unit 512 registers the first device 101 specified by the acquired identification information in association with the position of the transmitter 104 (S1003). The associated position of the transmitter 104 at this time is the position registered in the server device 103 in step S1001.

Next, the control unit 507 of the second device 101 transmits identification information to the server device 103 and requests the server device 103 to register the device 101 (S1004). When the management unit 512 of the server device 103 acquires the identification information transmitted from the second device 101 via the transmission/reception unit 511, the management unit 512 registers the second device 101 specified by the acquired identification information in association with the position of the transmitter 104 (S1005). The associated position of the transmitter 104 at this time is the position registered in the server device 103 in step S1001.

In the present embodiment, for example, an administrator inputs position information of the transmitter 104 to be registered in association with the device 101 into the device 101, and the position information input to the device 101 is transmitted to the server device 103 together with a request for registration of the device 101. Accordingly, the device 101 and the position of the transmitter 104 are associated with each other.

Additionally, hereinafter, it is assumed that both the first device 101 and the second device 101 are registered in the server device 103 in association with position information of the same transmitter 104 provided at an entrance of a building in which the first device 101 and the second device 101 are installed.

In the present embodiment, in a case of registering a plurality of devices 101 in association with position information of the same transmitter 104, the server device 103 registers one of the registered devices 101 as a representative device 101. Which device 101 is to be registered as a representative may be determined in accordance with an instruction from an administrator. Alternatively, the device 101 that is first registered in the server device 103 (the first device 101 in the above example) may be registered as the representative device 101. Next, a process related to a re-push notification will be explained.

After the initial push notification has been performed, the transmission/reception unit 921 of the transmitter 104 transmits a beacon signal to the surroundings (S1020). Additionally, the transmission/reception unit 921 continuously transmits the beacon signal.

When a user approaches the transmitter 104, the transmission/reception unit 521 of the user terminal 102 carried by the user receives the beacon signal (S1021).

The position management unit 523 of the user terminal 102 transmits, to the server device 103, position information of the transmitter 104 included in the beacon signal received by the transmission/reception unit 521 and requests the server device 103 to perform a re-push notification to the user terminal 102 (S1022).

When the control unit 513 of the server device 103 acquires position information from the user terminal 102 via the transmission/reception unit 511, the control unit 513 requests the device 101, which is registered in the management unit 512 in association with the acquired position information, to provide information for a re-push notification.

In this example, the control unit 513 requests the first device 101 to provide information for the re-push notification (S1023). In response to the request, the control unit 507 of the first device 101 transmits, to the server device 103, information to be notified to the user terminal 102 as the re-push notification, together with an instruction for the re-push notification (S1024).

Additionally, the control unit 513 requests the second device 101 to provide information for the re-push notification (S1025). In response to the request, the control unit 507 of the second device 101 transmits, to the server device 103, information to be notified to the user terminal 102 as the re-push notification, together with an instruction for the re-push notification (S1025).

Upon receiving instructions from the device 101, the control unit 513 of the server device 103 transmits the information acquired from the device 101 as notification information to the user terminal 102 that has requested the re-push notification, thereby performing the re-push notification (S1027).

When Service Worker, which is operated in the background by the control unit 524 of the user terminal 102, receives the re-push notification via the transmission/reception unit 521, Service Worker causes the content of the received re-push notification to be displayed on the input/output device 308 (S1028).

Note that, as described above, there may be a case in which re-push notifications from a plurality of devices 101 associated with the same position information are instructed to the server device 103. In this a case, re-push notifications may be performed for the PWAs of the user terminals 102 corresponding to each of the respective devices 101 or may be performed only to the PWA of the device 101 registered as a representative in the server device 103. When the re-push notification is performed only to the PWA of the representative device 101 registered in the server device 103, it is possible to suppress the user from feeling annoyed due to receiving individual re-push notifications on the PWAs of the user terminals 102 corresponding to the respective devices 101.

Additionally, in a case in which the re-push notification is performed only to the PWA of the representative device 101, the content of the re-push notification may include contents of the re-push notifications corresponding to each device 101. In this case, for example, the control unit 513 of the server device 103 generates a group web site in which the re-push notifications for each of the devices 101 (including the installation information of the PWA) are grouped. Then, in a case in which the re-push notification is performed for the PWA of the representative device 101 on the user terminal 102, the control unit 513 includes URL information of the group web site in the content of the re-push notification. In this case, the re-push notifications corresponding to each of the devices 101 become confirmable by the user based on the URL information of the group web site displayed on the user terminal 102.

Additionally, in the present embodiment, when the transmitter 104 starts transmission of the beacon signal, the transmitter 104 provides a notification to the device 101 indicating the start of the transmission of the beacon signal. Upon receiving the notification from the transmitter 104, the device 101 performs a re-notification process (refer to FIG. 6). Additionally, in the present embodiment, when the device 101 receives a request for information for re-push notification from the server device 103, an affirmative result is obtained in step S801 (“Yes” in S801).

Next, an image displayed on the input/output device 308 of the user terminal 102 in a case in which a re-push notification is performed in the present embodiment will be explained. Hereinafter, a case will be explained in which re-push notifications are performed from the first device 101 and the second device 101, as explained with reference to FIG. 11.

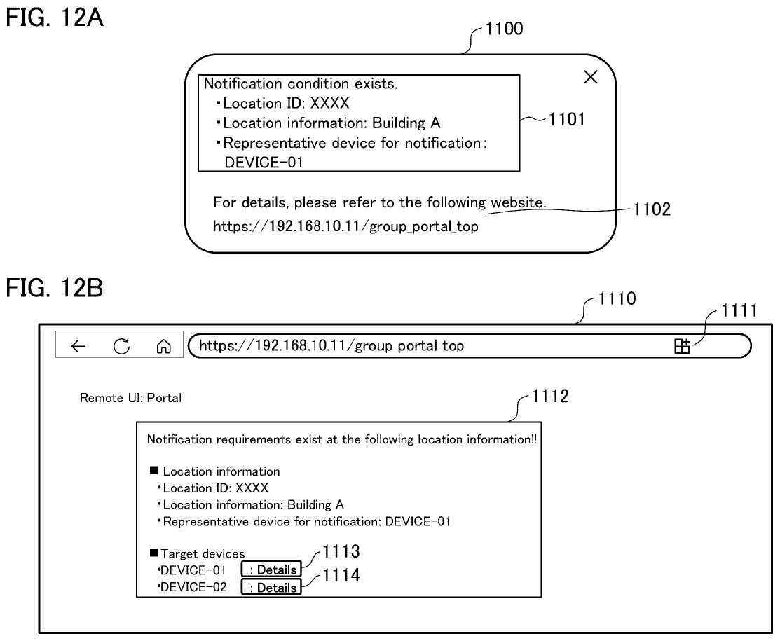

FIG. 12A is a diagram illustrating a re-notification screen 1100. The re-notification screen 1100 is a screen that is displayed on the user terminal 102 in a case in which a re-push notification is performed. That is, the re-notification screen 1100 is information notified to the user terminal 102 as a re-push notification. In the re-notification screen 1100, a target portion 1101 and a site notification portion 1102 are displayed.

In the target portion 1101, information related to the target of the re-push notification is displayed. Specifically, in the target portion 1101, position information of the transmitter 104 associated with the device 101 that has performed the re-push notification, information indicating the location at which the transmitter 104 is installed, and information identifying the device 101 registered as a representative in the server device 103 are displayed.

In the site notification portion 1102, URL information of a group web site, in which the re-push notifications for each device 101 are grouped, is displayed.

Here, when the user selects the site notification portion 1102, the group screen 1110 is displayed on the input/output device 308 of the user terminal 102, as illustrated in FIG. 12B. The group screen 1110 is a screen of the group website on which the contents of the re-push notifications for each device 101 can be confirmed. In the group screen 1110, a button 1111 and a group notification portion 1112 are displayed.

The button 1111 is a button displayed in a case in which the group web site screen displayed on the input/output device 308 can be installed as a PWA. In the group notification portion 1112, the contents of the notification requirements on the group web site are displayed. A button 1113 and a button 1114 displayed in the group notification portion 1112 are buttons for confirming the detailed contents of the notifications from the first device 101 and the second device 101. That is, in the group notification portion 1112, buttons for confirming the detailed content of notifications from each device 101, for which the re-push notification has been performed, are displayed. Then, when the button is selected, the PWA of the terminal site of the device 101 corresponding to the selected button is launched, and the content of the re-push notification from the device 101 is displayed.

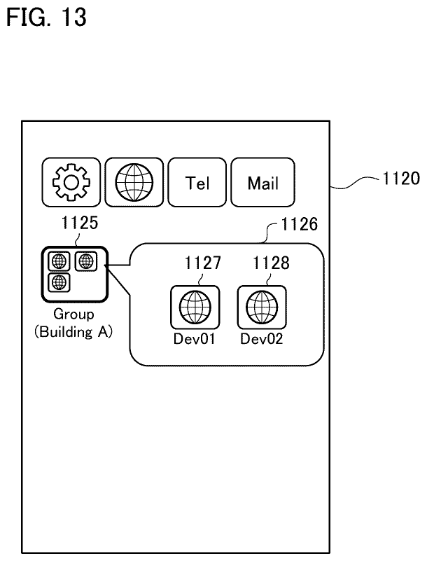

FIG. 13 is a diagram illustrating a top screen 1120 displayed on the user terminal 102 after the PWA of the group web site has been installed on the user terminal 102 (following installation due to selection of the button 1111).

On the top screen 1120, icons corresponding to respective functions of the user terminal 102 are displayed. Additionally, on the top screen 1120, a group icon 1125 is displayed. The group icon 1125 is an icon of the PWA of the group web site and is displayed after the PWA of the group web site is installed in response to selection of the button 1111 (refer to FIG. 12B). The group icon 1125 is displayed as if a plurality of native applications is grouped together.

Here, when the user performs a long press on the group icon 1125, a pop-up image 1126 is displayed on the top screen 1120. In the pop-up image 1126, a first device icon 1127 that is the icon of the PWA of the first device 101 and a second device icon 1128 that is the icon of the PWA of the second device 101 are displayed.

When the user presses the first device icon 1127, the PWA of the terminal site of the first device 101 is launched. When the user presses the second device icon 1128, the PWA of the terminal site of the second device 101 is launched.

As described above, in the present embodiment, by grouping icons of PWAs corresponding to terminal sites of the devices 101, the time-consuming effort required for a user to search for icons corresponding to each device 101 is reduced.

Additionally, in the function providing system 1 according to the present embodiment, as described above, the approach of the user terminal 102 to the device 101 is detected in a stepwise manner, and re-push notifications from the device 101 to the user terminal 102 are performed at each stage at which the approach is detected. For example, it is assumed that transmitters 104 are installed respectively at the entrance of a building in which the device 101 is provided, and at an entrance of a room within the building in which the device 101 is provided. In this case, after the initial push notification has been performed, a re-push notification from the device 101 to the user terminal 102 is performed based on the user terminal 102 approaching the building entrance and receiving a beacon signal transmitted from the transmitter 104 installed at the building entrance. Thereafter, based on the user terminal 102 approaching the entrance of the room in the building in which the device 101 is provided and receiving a beacon signal transmitted from the transmitter 104 installed at the room entrance, a re-push notification from the device 101 to the user terminal 102 is again performed.

That is, the range conditions include a first range condition and a second range condition, the latter being defined as the condition in which the user terminal 102 is positioned closer to the device 101 than under the first range condition. The first range condition includes, for example, that the user terminal 102 is recognized as having approached the entrance of the building in which the device 101 is provided, without having approached the entrance of the room in which the device 101 is provided. Additionally, the range satisfying the first range condition includes, for example, a range in which the user terminal 102 can receive a beacon signal from the transmitter 104 at the building entrance but cannot receive a beacon signal from the transmitter 104 at the room entrance. Additionally, the second range condition includes, for example, that the user terminal 102 is recognized as having approached the entrance of the room in which the device 101 is provided. Additionally, the range that satisfies the second range condition includes, for example, a range in which the user terminal 102 is capable of receiving the beacon signal from the transmitter 104 located at the entrance of the room. After the initial push notification has been performed, in a case in which the user terminal 102 is located within a range that satisfies the first range condition but does not satisfy the second range condition, the control unit 507 causes a re-push notification to be performed for the user terminal 102. Thereafter, in a case in which the user terminal 102 is located within a range that satisfies the second range condition, the control unit 507 causes a re-push notification to be performed for the user terminal 102.

In this case, it is possible to cause the user to recognize that the user is approaching the device 101 stepwise.

Note that although in the present disclosure, it has been explained that the position of the device 101 is specified by the user terminal 102 based on a beacon signal transmitted from the device 101 or the transmitter 104 being received by the user terminal 102, the present disclosure is not limited thereto. For example, the positional relation between the user terminal 102 and the device 101 may be specified by the device 101 and/or the user terminal 102 having a global positioning system (GPS) function, or by the device 101 and the user terminal 102 communicating with each other via Wi-Fi (registered trademark). In this case, determination as to whether the user terminal 102 is located within a range that satisfies a range condition (such as the range condition, the first range condition, or the second range condition) may be performed by the user terminal 102 or by the device 101. Additionally, the determination of whether or not the user terminal 102 is located in a range that satisfies the range condition (such as range condition, first range condition, or second range condition) may be performed by the server device 103, to which the positional relationship between the user terminal 102 and the device 101 has been reported from the user terminal 102 and/or the device 101. Even in such cases, the device 101 can cause a re-push notification to be performed for the user terminal 102 via the server device 103, in accordance with whether or not the user terminal 102 is located within a range that satisfies the range condition, the first range condition, the second range condition, and the like.

Additionally, the content of the push notification is not limited to the above-described example. The push notification may include information indicating the state described above as the state detected by the detection unit 505.

Additionally, in the present disclosure, the content of the push notification in the case in which the device 101 is a multifunction peripheral has been explained. Here, in the function providing system 1 of the present disclosure, a push notification having content corresponding to the type of the device 101, such as a network router, a monitoring camera, a digital medical device, an automobile, a delivery box, or a locker, is performed.

For example, in a case in which the device 101 is an automobile, the content of the push notification may include information such as a failure of an automobile component (for example, a burned-out lamp or a flat tire), travel distance, and warnings. Additionally, examples of warnings include a warning indicating an increased risk of failure of the vehicle body or components in a case in which the usage period after component replacement reaches a predetermined value, a warning indicating that a vehicle inspection date is approaching, and a warning indicating that a predetermined period has elapsed since the previous inspection.

Additionally, for example, in a case in which the device 101 is a delivery box or a locker, examples of the content of the push notification include notifications that a delivery item or stored item is present, that the storage period has exceeded a predetermined threshold, and that a failure has occurred in the device 101. Furthermore, it may be possible for a delivery person or a storage user to register the contents of the delivery or stored items in the delivery box or locker. In this case, the content of the push notification may be determined according to the registered content. For example, in a case in which the delivery article or the stored article is food or drink, the content of the push notification may be determined to prompt taking out the food or beverage in consideration of an expiration date.

Additionally, the present disclosure also includes cases in which a software program realizing the functions of the above-described embodiment is supplied to a system or apparatus having a computer capable of executing the program, either directly from a recording medium or via wired or wireless communication, and the program is executed.

Accordingly, the program code itself, which is supplied to and installed on the computer to realize the functional processing of the present disclosure by the computer, also constitutes part of the present disclosure. That is, a computer program for realizing the functional processing of the present disclosure itself is also included in the present disclosure. In this case, the program may take any form, such as object code, a program executed by an interpreter, or script data supplied to an operating system, provided that it has the function of the program. Examples of recording media for supplying the program include magnetic recording media such as a hard disk and magnetic tape, optical or magneto-optical storage media, and nonvolatile semiconductor memories. Additionally, as a method of supplying the program, a method may be considered in which a computer program constituting the present disclosure is stored in a server on a computer network, and a client computer that has connected thereto downloads the computer program and installs the program.

Additionally, based on instructions of the program code, an OS and the like running on the computer may perform part or all of the actual processing, and the functions of the above-described embodiment may be realized through such processing. Furthermore, the program code read out from the recording medium may be written into a memory provided in a function expansion board inserted into the computer or a function expansion unit connected to the computer. Based on the instructions of the program code, a CPU and the like provided in the function expansion board or the function expansion unit may execute part or all of the actual processing. Even in such a case, each of the functions of the above-described embodiments may be realized.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

According to the present disclosure, it is possible to cause a user who has approached a network device that has a requirement to notify a user terminal to recognize the presence of the network device, without requiring, for each user terminal, a setting of notification from the network device in the user terminal.

This application claims the benefit of Japanese Patent Application No. 2024-153688, filed Sep. 6, 2024, which is hereby incorporated by reference wherein in its entirety.

What is claimed is:

1. A network device comprising:
at least one memory storing instructions; and
at least one processor executing the stored instructions causing the network device to:
perform notification processing to display a first push notification on a user terminal in which software as a progressive web application for providing information regarding a state of the network device is installed, when a current state of the network device is in a state satisfying a predetermined state condition; and
perform the notification processing to display a second push notification on the user terminal, when the user terminal is located within a range satisfying a predetermined range condition with respect to the network device after the first push notification has been displayed on the user terminal.

2. The network device according to claim 1, wherein executing the stored instructions by the processor further causes the network device to transmit an activation instruction to activate the software as the progressive web application on the user terminal in a case where the notification processing to display the second push notification on the user terminal is performed.

3. The network device according to claim 2, wherein the software as the progressive web application is activated on the user terminal based on a predetermined operation by a user on the user terminal in addition to the activation instruction.

4. The network device according to claim 1,
wherein the predetermined state condition includes a first state condition and a second state condition different from the first state condition, and
wherein the notification processing to display the second push notification on the user terminal is performed by the network device when, after the first push notification has been displayed on the user terminal, the user terminal is located within the range satisfying the predetermined range condition and the current state of the network device is in a state satisfying the first state condition, and
the notification processing to display the second push notification on the user terminal is not performed by the network device when, after the first push notification has been displayed on the user terminal, the user terminal is located within the range satisfying the predetermined range condition and the current state of the network device is in a state satisfying the second state condition.

5. The network device according to claim 4,
wherein executing the stored instructions by the processor further causes the network device to provide a reception screen configured to receive one or more settings relating to the state satisfying the first state condition.

6. The network device according to claim 1, wherein executing the stored instructions by the processor causes the network device to restrict the notification processing to display the second push notification on the user terminal even in a case where, when a predetermined time has not elapsed after the first push notification has been displayed on the user terminal, the user terminal is located within a range satisfying the predetermined range condition.

7. The network device according to claim 1, wherein the notification processing to display the second push notification on the user terminal includes at least one of: information relating to a start time at which the network device enters a state satisfying the predetermined state condition; information corresponding to an elapsed time since the network device has been in the state satisfying the predetermined state condition; and information corresponding to a number of times the notification processing to display the first push notification on the user terminal is performed.

8. The network device according to claim 1,
wherein the predetermined range condition includes a first range condition and a second range condition, the second range condition being defined such that the user terminal is located within a range closer to the network device than the first range condition,
wherein executing the stored instructions by the processor causes the network device to:
perform the notification processing to display the second push notification on the user terminal, when the user terminal is located within a range satisfying the first range condition while not satisfying the second range condition after the first push notification has been displayed on the user terminal; and
perform the notification processing to display the second push notification on the user terminal, when the user terminal is located within a range satisfying the second range condition after the second push notification has been displayed on the user terminal in response to the user terminal being located within the range satisfying the first range condition while not satisfying the second range condition.

9. A method for controlling a network device, the method comprising:
performing notification processing to display a first push notification on a user terminal in which software as a progressive web application for providing information regarding a state of the network device is installed, when a current state of the network device is in a state satisfying a predetermined state condition; and
performing notification processing to display a second push notification on the user terminal, when the user terminal is located within a range satisfying a predetermined range condition with respect to the network device after the first push notification has been displayed on the user terminal.

10. A non-transitory storage medium storing a program of a network device causing a computer to perform each step of a method for the network device, the method comprising:
performing notification processing to display a first push notification on a user terminal in which software as a progressive web application for providing information regarding a state of the network device is installed, when a current state of the network device is in a state satisfying a predetermined state condition; and
performing notification processing to display a second push notification on the user terminal, when the user terminal is located within a range satisfying a predetermined range condition with respect to the network device after the first push notification has been displayed on the user terminal.
